(19) United States
(12) Patent Application Publication
(10) Pub. No.: US 2003/0154587 A1
(43) Pub. Date: Aug. 21, 2003

(54) Method and apparatus for feeding part

(76) Inventors: Yoshitaka Aoyama, Sakai-shi (JP); Shoji Aoyama, Sakai-shi (JP)

Correspondence Address: J C Patents Inc, Suite 250, 4 Venture, Irvine, CA, 92618, US

(21) Appl. No.: 10/275,728

(22) PCT Filed: Sep. 27, 2001
(86) PCT No.: PCT/JP01/08474

(30) Foreign Application Priority Data
Feb. 5, 2001 (JP) 2001-69435

(51) Int. Cl. B23P 11/00

(52) U.S. Cl. 29/428; 29/771; 29/809

(57) ABSTRACT

A part supply device comprises a robot device, a part supply unit installed onto a head member of the robot device, a reciprocating supply rod arranged in the part supply unit, a holding means for holding a part arranged at a front end of the supply rod, and a part supply passage extending from a part feeder and exits near by the front end of the supply rod.

### CROSS-REFERENCE TO RELATED APPLICATION

This application claims the priority benefit of Japanese Patent Application No. 2001-69435, filed on Feb. 5, 2001.

### BACKGROUND OF THE INVENTION

1. Field of the Invention

This invention relates in general to a method and a device for automatically supplying parts to a desired location, and more specifically relates to a robot device and part supply unit that are functionally assembled to supply parts.

2. Description of Related Art

It is well known to use a robot device to supply a bolt with a flange, a projection nut etc. to a desired location. Because the head member at the front end of the robot device can freely move in a desired direction, it is also well known to install a chuck mechanism for parts onto the head member. During supplying of the parts, the parts held in the chuck mechanism can be carried to a desired location by the moving of the robot device. device.

In the conventional technique described above, because the held parts are supplied by the robot device, the style of supplying is limited. For example, to insert a shaft-shaped part such as a bolt with a flange into a receiving hole, the bolt may not be inserted completely by only using a robot device. Although, a robot device is typically of a six-axis type and its head member can make complex and different kinds of motions, it may be impossible to supply a small part such as the bolt mentioned above to a special location. However, a general type robot device should be used, advantageously without being specially transformed.

### SUMMARY OF THE INVENTION

For solving the problems described above, an object of this invention is to provide a composite part supply robot device wherein original functions of a robot device and special functions of a part supply unit installed in the robot device are combined.

According to an aspect of the present invention, a part supply device comprises: a robot device having a head member at a front end thereof for movement in desired locations, a part supply unit attached to the head member, and a reciprocating supply rod installed in the part supply unit. In addition to the function of the robot device, the reciprocating supply rod is used so that the shaft-shaped part such as a bolt with a flange can be completely inserted into a receiving hole in a mating part. Especially, even though the part is to be inserted in a hole situated in a narrow and close shape where it is very difficult to put the part in position manually, the part can be supplied easily according to the present invention. By assembling the part supply unit to the head member, the functions of the robot device can be further improved. Therefore, the general type robot device can be used without being transformed, so it is also economic.

The part supply device may further comprises a part holding means provided at a front end of the supply rod and a part supply passage extending from a part feeder and opening near the front end of the supply rod. The shaft-shaped part, which is constantly supplied through the part supply passage, is transferred from the opening of the part supply passage to the front end of the supply rod, and then kept on the front end of the supply rod. Therefore, when the robot device continuously supplies the part in sequence, the part is kept on the front end of the supply rod in sequence, and an efficient supply without interruption can be achieved. It is indispensable to hold parts at the front end of the supply rod for as short a time as possible when parts are to be supplied to one after the other to many locations. This invention can satisfy all these conditions. Therefore, a supply operation with high efficiency can be achieved.

Furthermore, the part supply device may comprise a robot device having a head member at a front end thereof for movement in desired directions, a part supply unit attached to the head member, a second reciprocating driving means installed in the head member, a supply rod installed in the second driving means and movable back and forth by a first reciprocating driving means, and a holding means for holding a shaft-shaped part provided at a front end of the supply rod, wherein a direction in which the second driving means reciprocates and an axis of the shaft-shaped part held on the supply rod are set to be in the same direction. In addition to the free motion of the head member, the back-and-forth moving of the supply rod, the back-and-forth direction of the second driving means and the axis of the shaft-shaped part held on the supply rod are set in the same direction. Therefore, the shaft-shaped part can be completely inserted into a special location. Specifically, first, the relative positions of the part supply unit and a receiving hole as a destination is set by moving the head member. Next, an advance of the supply rod places the shaft-shaped part and the receiving hole in a coaxial state. Finally, the shaft-shaped part is inserted into the receiving hole by an advance stroke of the second driving means. Moreover, the second driving means is combined to the head member of the robot device, so that if the second driving means is actuated for advance, the supply rod will also advance whereby, the shaft-shaped part can be precisely inserted into a receiving hole situated in a narrow and close shape.

The supply passage extending from a part feeder may have an exit opening near the front end of the supply rod. A part can be supplied through the part supply passage at a right time, and then is moved through the opening and kept on the front end of the supply rod. Therefore, a part can be sent out at a right time by fitting the motions of the robot device and the part supply unit ensuring a part supply with efficiency. Because the exit opening of the part supply passage is close to the front end of the supply rod, the part can be correctly moved through the exit opening to the front end of the supply rod, resulting in a high reliability of the motion of the device.

According to another aspect of the present invention, a part supply method uses a part supply device comprising: a robot device having a head member at a front end thereof for movement in desired directions, a part supply unit installed onto the head member, a second reciprocating driving means combined to the head member, a supply rod installed on the second reciprocating driving means and movable back and forth by a first reciprocating driving means, and a holding means for holding a shaft-shaped part arranged at a front end of the supply rod, wherein a direction in which the second driving means reciprocates and an axis of the shaft-shaped part held on the supply rod are set to be in the same direction. The part supply method comprises: moving the head member to set relative positions of the part supply unit and a receiving hole as a destination, causing the supply rod to advance so as to make the shaft-shaped part and the receiving hole coaxial, and actuating the second driving means so as to insert the shaft-shaped part into the receiving hole. In addition to the free motion of the head member, the back-and-forth moving of the supply rod, the back-and-forth direction of the second back-and-forth driving means and the axial of the shaft-shaped part held on the supply rod are set in the same direction. Therefore, the insertion of the shaft-shaped part can be completely effected even in a special location. Specifically, first, the head member is moved so as to set relative positions of the part supply unit and a receiving hole as a destination. Next, the supply rod advances to make the shaft-shaped part and the receiving hole coaxial. Finally, the second driving means is actuated so as to insert the shaft-shaped part into the receiving hole. In this way, the head member is moved to a predetermined location, where the supply rod is extended from the head member so that the shaft-shaped part is inserted into the receiving hole by the second driving means. In other words, the part supply unit is moved to a predetermined location by the robot device. The part supply unit in turn carries out the supply of the shaft-shaped part. Since the supply rod advances even in a narrow and close shape, the part can be successfully supplied. Especially, due to the fact that the direction in which the second driving means reciprocates and the axis of the shaft-shaped part held on the supply rod are set in the same direction, the slim supply rod can enter a narrow space, holding the part and then the supply rod is further moved by the second driving means. Therefore, it is possible to supply a part to a location where a part could not be supplied completely only by using a robot device.

### BRIEF DESCRIPTION OF THE DRAWINGS

While the specification concludes with claims particularly pointing out and distinctly claiming the subject matter which is regarded as the invention, the objects and features of the invention and further objects, features and advantages thereof will be better understood from the following description taken in connection with the accompanying drawings in which:

FIG. 1 is a schematic elevation view showing the whole body of the part supply device according to the present invention;

FIG. 2 is an enlarged view showing a portion of the part supply device shown in FIG. 1;

FIG. 3 is a longitudinal sectional view of the supply rod;

FIG. 4 is a side view showing the whole body of the robot device;

FIG. 5 is a plan view of an embodiment in which bolts are mounted on a steel pipe;

FIG. 6 is an elevation of the device shown in FIG. 5; and

FIG. 7 is a longitudinal sectional view of the socket unit shown in FIG. 6.

### DESCRIPTION OF THE PREFERRED EMBODIMENT

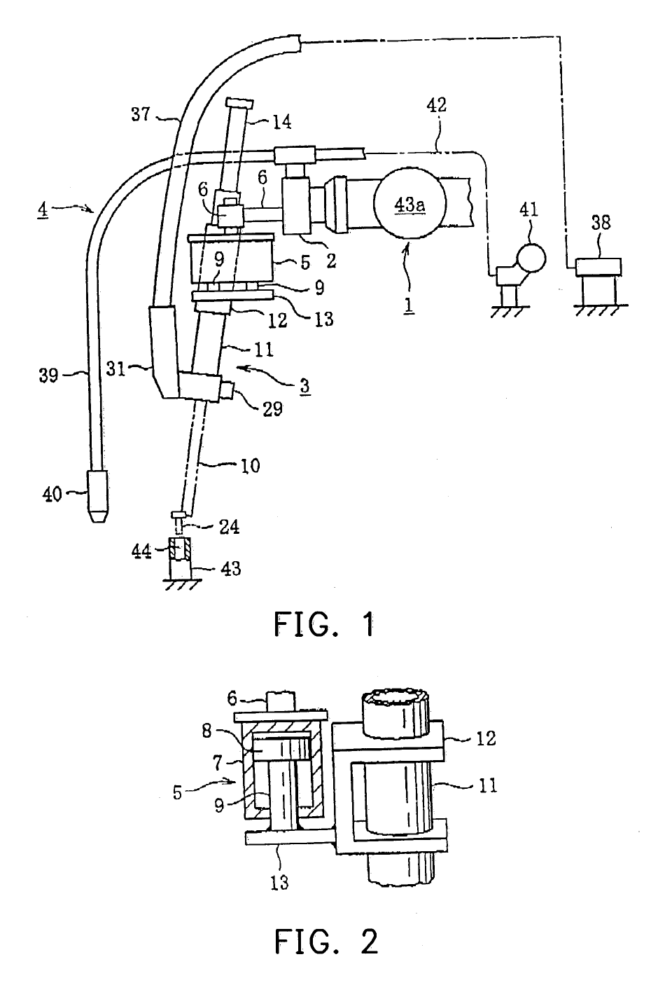

FIG. 1 is a side view showing a whole structure of the parts supplying device of the present invention. The reference numeral 1 generally represents the whole structure of the robot device. A head member 2 is connected to the front end of the robot device 1. A part supply unit 3 is installed onto the head member 2, and an arc-welding unit 4 is also fixed onto the head member 2. An air cylinder 5 serving as the second driving means is tightly fixed onto the head member 2 through a connection member 6. In the air cylinder 5, a piston 8 is inserted into a cylinder 7, and piston rods 9 protrude out of the cylinder 7 as shown in FIG. 2. As described above, the connection member 6 is fixed onto the upper portion of the cylinder 7, and the air cylinder 5 if firmly connected to the head member 2.

A supply rod 10 is supported on the air cylinder 5. An external cylinder 11 is set in the air cylinder 5 for receiving a supply rod 10. The external cylinder 11 is tightly fixed (welding for example) in the bracket 12 having a channel shape as shown in FIG. 2. A connection plate 13 welded onto the bracket 12 is fixed onto the piston rods 9. The air cylinder 5 is a tandem type, so that two piston rods 9 protrude as shown in FIG. 1. The connection plate 13 is fixed onto the two position rods 9. It is noted that the air hose that should to be shown in the air cylinder 5 is omitted in FIG. 1.

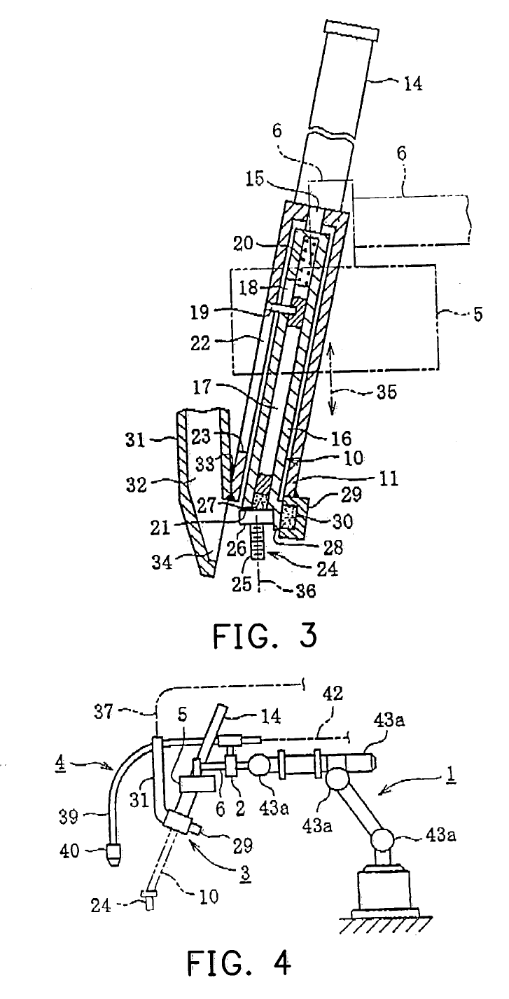

The mechanism for causing the supply rod 10 to reciprocate will be described with reference to FIG. 3. An air cylinder 14 serving as a first driving means is combined in the upper end of the external cylinder 11. A piston rod 15 of the air cylinder enters the external cylinder 11 and is connected with the supply rod 10. It is noted that the air hose of the air cylinder 14 is also omitted. A holding means is arranged at the front end of the supply rod 10. Though various members such as a chuck mechanism, or a vacuum style member could be used as the holding means, the magnet is used here. After the supply rod 10 advances a predetermined stroke, the magnetic attraction has to be canceled to release the part from the supply rod 10. To that end, the supply rod 10 is constructed as a dual structure.

An inner shaft 17 is slidably inserted into a pipe-shaped outer shaft 16. An elongated hole 18 is formed in the outer shaft 16 along the axial direction of the supply rod 10. An engaging pin 19 fixed in the inner shaft 17 passes through the hole 18 and protrudes outward. A compression coil spring 20 is inserted into the outer shaft 16. The engaging pin 19 is in contact with the lower end of the hole 18 by the action of the coil spring 20. Under this condition, the end faces of inner shaft 17 and the outer shaft 16 form a plane that serves as a holding surface 21 for parts. Another elongated hole 22 is formed in the external cylinder 11 along the axial direction of the supply rod 10. The engaging pin 19 extends through the hole 22. An end portion 23 of the hole 22 is located at the advance stroke end of the supply rod 10.

Here, the parts being handled represented by the reference numeral 24 are shaft-shaped parts or bolts, which are made of iron, and each comprises a shank portion 25 and a little thicker flange 26. The external cylinder 11, the inner shaft 17 and the outer shaft 17 etc. are of round cross section.

A permanent magnet 27 is combined to the front end of the inner shaft 17. The end face of the flange 26 is fast fixed onto the holding surface 21 due to the attraction of the permanent magnet 27. A stopper plate 28 for stopping the outer periphery of the flange 26 protrudes from the end portion of the outer shaft 16. A block 29 is welded onto the end portion of the external cylinder 11 and a permanent magnet 30 is embedded in the external cylinder 11. The bolt 24 is attracted onto the holding surface 21 and the stopper plate 28 by two permanent magnets 27 and 30. Therefore, the holding means arranged at the front end of the supply rod 10 is constructed by the holding surface 21, the permanent magnet 27, the stopper plate 28 etc.. For strengthening the attraction of the magnets 27 and 30 with respect to the bolt 24, the outer shaft 16, the inner shaft 17, the stopper plate 28 and the block 29 etc. are preferably of non-magnetic material, such as stainless steel. Furthermore, the magnets 27 and 30 can be replaced by an electromagnet.

A part supply pipe 31 is welded onto the external cylinder 11. A supply passage 32 formed inside the part supply pipe 31 has an exit opening near the front end of the supply rod 10. The part supply pipe 31 is welded at the location 33 to form an acute angle with respect to the external cylinder 11. The part supply pipe 31 has an opening 34 facing the bolt 24. The bolt 24 that has arrived at the opening 34 is moved and kept at the position as shown in FIG. 3 by the attraction of the magnets 27 and 30.

When the air cylinder 5 operates, the external cylinder 11 and the supply rod 10 move together. The direction in which the piston rod 9 of the air cylinder 5 reciprocates is shown by the arrow 35. The arrow 35 is set to be the same direction as the axis 36 of the shank 25 of the bolt 24 that is temporarily held by the magnets 27 and 30. In other words, the arrow 35 and the axis 36 are parallel to each other as shown in FIG. 3. As shown in FIG. 1, the part supply pipe 31 is connected to the part feeder 38 through a hose 37 made of flexible synthetic resin. In the arc-welding unit 4, a welding torch 40 is combined to the front end of a supporting pipe 39 that is fixed onto the head member 2. A metal electrode wire 42 that is drawn from a wire reel 41 is delivered out through the welding torch 40 in sequence.

In the case of the FIG. 1 arrangement, the desired location for supplying the bolt 24 is a receiving hole 44 formed in a socket 43. The relative positions of the axis 36 of the shaft 25 and the receiving hole 44 are set in advance so that when the supply rod 10 advances to possess a predetermined location, they become coaxial.

FIG. 4 shows the robot device 1, which is the general type one such as six-axial type. The arm is connected to the robot device 1 through a joint driving unit 43a so that the head member 2 can make a free motion.

The operation of the embodiment described above will be described. When the supply rod 10 retrocedes to the back most position and the bolt 24 is sent to the part supply pipe 31, the bolt 24 moves from the opening 34 to the front end of the supply rod 10 and is kept at the front end of the supply rod 10. Under this condition, the head member 2 is stopped at a predetermined location due to the operation of the robot device 1. The predetermined location is the place where the bolt 24 and the receiving hole 44 are coaxial when the supply rod 10 advances. After that, when the air cylinder 14 actuates the supply rod 10 to advance, the bolt 24 is advanced without changing the relative positions of the inner shaft 17 and the outer shaft 16. When the bolt 24 comes close to the receiving hole 44 and the engaging pin 19 is in contact with the end 23 of the hole 22, the movement of the inner shaft 17 is stopped so as to follow the outer shaft 16 to advance further. Therefore, the magnet 27 is gradually spaced apart from the flange 26 to release the attraction to the bolt 24. When the attraction gradually disappears, the air cylinder 5 operates to insert the shaft 25 into the receiving hole 44. During the transition period that the shaft 25 is inserted to the receiving hole 44, the attraction of the magnet 27 is gone, and the supply of the bolt 24 towards the receiving hole 44 is completed.

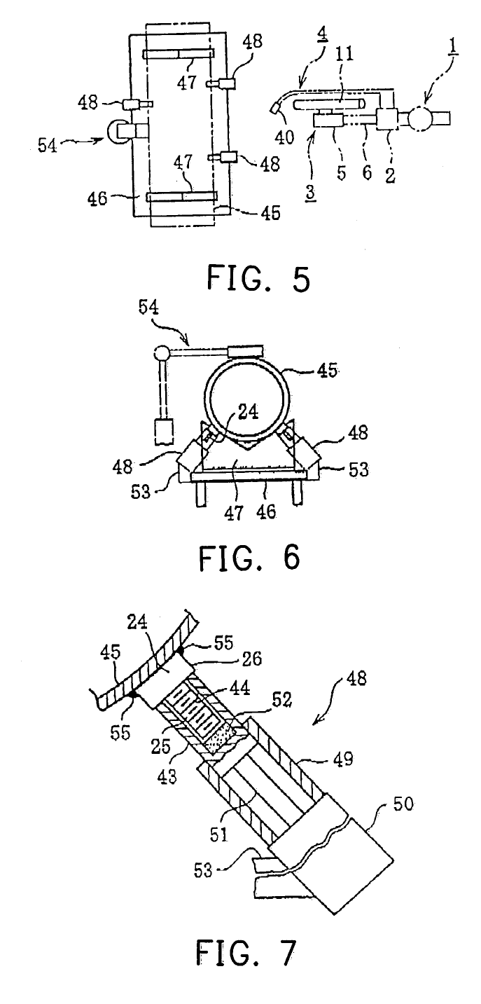

FIGS. 5 to 7 show that the flange 26 of the bolt 24 is welded to the outer peripheral surface of a steel pipe 45. Upright V blocks 47 made of thick plate are fixed onto a supporting plate 46. A socket unit 48 is installed onto the supporting plate 46. Each socket unit 48 has a socket 43 with a receiving hole 44 as shown in FIG. 7. The socket 43 is slidably received in a guide pipe 49. An air cylinder 50 is combined to the guide pipe 49 with a piston rod 51 thereof connected to the socket 43. A permanent magnet 52 is inserted in the inmost part of the receiving hole 44 to prevent the bolt 24 from falling down. The socket unit 48 is fixed onto the supporting plate 46 through a suitable bracket 53 or the like.

The steel pipe 45 is carried on the V blocks 47 and is pressed against by a clamp mechanism 54. The mechanism 54 can be a general one, using a cylinder, a pressing arm and the like. The part supply unit 3 is as shown in the two-dot chain lines in FIG. 5.

The operation of this embodiment will be described. The robot device 1 and the part supply unit 3 operate as described above to insert the bolt 24 in the receiving hole 44 of each socket 43 before the steel pipe 45 is placed on the V blocks 47. The bolt 24 is inserted into each of the receiving holes 44 which point to various directions in sequence with to the free motion of the robot device 1 as well as the part supply unit 3. After that, the steel pipe 45 is carried on the V blocks 47 and is fixed by the clamp mechanism 54. At that time, the socket 43 is pushed out by the air cylinder 50 so that the flange 26 is fast fixed onto the outer peripheral surface of the steel pipe 45. Next, the welding torch 40 of the welding unit 4 approaches the welding location of the flange 26 to weld the bolt 24 as at 55 in FIG. 7. After that, the socket 43 is retracted by the air cylinder 50 and the clamping by the clamp mechanism 54 undone, and then the steel pipe 45 with bolts 24 is taken out.

While the present invention has been described with a preferred embodiment, this description is not intended to limit our invention. Various modifications of the embodiment will be apparent to those skilled in the art. It is therefore contemplated that the appended claims will cover any such modifications or embodiments as fall within the true scope of the invention.

What is claimed is:

1. A part supply device, comprising:
a robot device having a head member at a front end thereof for movement in desired directions;
a part supply unit attached to the head member; and
a reciprocating supply rod installed in the part supply unit.

2. The part support device of claim 1, further comprising a part holding means provided at a front end of the supply rod and a part supply passage extending from a part feeder and opening near a front end of the supply rod.

3. A part supply device, comprising:
a robot device having a head member at a front end thereof for movement in desired directions;
a part supply unit attached to the head member;
a second reciprocating driving means installed in the head member;
a supply rod installed in the second driving means and movable back and forth by a first reciprocating driving means; and
a holding means for holding a shaft-shaped part provided at a front end of the supply rod,
wherein a direction in which the second driving means reciprocates and an axis of the shaft-shaped part held on the supply rod are set to be in the same direction.

4. The part supply device of claim 3, wherein a part supply passage extending from a part feeder has an exit opening near the front end of the supply rod.

5. A part supply method, using a part supply device comprising:
a robot device having a head member at a front end thereof for movement in desired locations;
a part supply unit attached to the head member;
a second reciprocating driving means installed in the head member;
a supply rod installed in the second driving means and movable back and forth by a first reciprocating driving means; and
a holding means for holding a shaft-shaped part provided at a front end of the supply rod, wherein a direction in which the second driving means reciprocates and an axis of the shaft-shaped part held on the supply rod are set to be in the same direction, the part supply method comprising:
moving the head member to set relative positions of the part supply unit and a receiving hole as a destination;
causing the supply rod to advance so as to make the shaft-shaped part and the receiving hole coaxial; and
actuating the second driving means so as to insert the shaft-shaped part into the receiving hole.
